(19) United States
(12) Patent Application Publication
(10) Pub. No.: US 2018/0354464 A1
(43) Pub. Date: Dec. 13, 2018

(54) WINDSCREEN WIPER DEVICE

(71) Applicant: FEDERAL-MOGUL S.A., AUBANGE (BE)

(72) Inventor: VALENTIN LALLEMAND, MARCHEVILLE-EN-WOEVRE (BE)

(21) Appl. No.: 15/781,347

(22) PCT Filed: Dec. 4, 2015
(86) PCT No.: PCT/EP2015/078685

§ 371 Date: Jun. 4, 2018

(51) Int. Cl. B60S 1/38

(52) U.S. Cl. CPC B60S 1/3805; B60S 1/3848; B60S 2001/3898; B60S 2001/3829; B60S 2001/3836; B60S 1/3808

(57) ABSTRACT

A windscreen wiper device (1) of the flat blade type, includes an elastic, elongated carrier element, as well as an elongated wiper blade (2) of a flexible material, which can be placed in abutment with a windscreen to be wiped. The wiper blade includes at least one longitudinal groove (3), in which groove at least one longitudinal strip of the carrier element is disposed. A connecting device is provided for an oscillating arm. An electrically conductive coating (12) is provided on at least a part of the flexible material of the wiper blade along at least a portion of its length in order to transfer electrically generated heat to the wiper blade upon applying a voltage to the electrically conductive coating.

### BACKGROUND

### 1. Technical Field

The present invention relates to a windscreen wiper device of the flat blade type, particularly for automobiles, comprising an elastic, elongated carrier element, as well as an elongated wiper blade of a flexible material, which can be placed in abutment with a windscreen to be wiped, which wiper blade includes at least one longitudinal groove, in which groove at least one longitudinal strip of the carrier element is disposed, which windscreen wiper device comprises a connecting device for an oscillating arm, wherein the oscillating arm can be pivotally connected to the connecting device about a pivot axis near one end thereof. Particularly, the oscillating arm can be pivotally connected to the connecting device with the interposition of a joint part. More in particular, the wiper blade comprises a spoiler at a side thereof facing away from the windscreen to be wiped, wherein the wiper blade and the spoiler are preferably made in one piece through extrusion. the longitudinal groove is preferably a central longitudinal groove accommodating the longitudinal strip. the longitudinal strip is also called a “flexor”, while the connecting device is also indicated as a “connector”. In the framework of the present invention the connector is preferably made in one piece, also called a “one piece connector”.

### 2. Related Art

Such a windscreen wiper device is generally known. This prior art windscreen wiper device is designed as a so-called “flat blade” or “yokeless blade”, wherein no use is made of several yokes pivotally connected to each other, but wherein the wiper blade is biassed by the carrier element, as a result of which it exhibits a specific curvature. The spoiler is also called an “air deflector”. In cold conditions, such as in freezing conditions, for example in winter time, the wiper blade of the known windscreen wiper device may lose (some of) its flexibility, so that wiping properties are deteriorated. Also, the wiper blade may be blocked by snow and/or ice, resulting in a bad wiping performance. Also, snow and/or ice may prevent a wiping lip of the wiper blade to tumble over at each turning point of its oscillatory movement, leading to a significant “rattling” noise and chatter. the wiping lip may even freeze onto a windscreen to be wiped resulting in a damage of the flexible material of the wiper blade.

### SUMMARY

The object of the invention is to provide an improved windscreen wiper device. More in particular, the present invention aims to keep the wiping properties of the wiper blade thereof at a constant high level, also in cold (freezing) conditions.

In order to accomplish that objective, a windscreen wiper device of the type referred to in the introduction is characterized according to the invention in that an electrically conductive coating is provided on at least a part of the flexible material of the wiper blade along at least a portion of its length in order to transfer electrically generated heat to the wiper blade upon applying a voltage to the electrically conductive coating. By applying the electrically conductive coating on a skin of the wiper blade it is possible to subject the coating to a voltage, so that the skin will heat up. The skin will then transfer its heat to other parts of the wiper blade in order to melt any snow and/or ice on the wiper blade. Particularly, in case the electrically conductive coating would have an electrical resistance of 6 or 12 Ohm, a voltage of 12 V or 24 V, respectively (dependent on the type of car), would be applied thereon to heat up the skin of the wiper blade, the coating is preferably provided along the entire length of the wiper blade.

It is noted that the present invention is not restricted to the use of only one longitudinal strip forming the elastic carrier element that is particularly located in a central longitudinal groove of the wiper blade. Instead, the carrier element may also comprise two longitudinal strips, wherein the strips are disposed in opposite longitudinal grooves of the wiper blade. the groove (s) may be closed at one outer end.

Further, it is noted that in the invention use is made of a mounting head fixed for rotation to a shaft, wherein the shaft is rotatable alternately in a clockwise and in a counter-clockwise sense carrying the mounting head into rotation. Thus, in turn the mounting head draws the connecting device into rotation and thereby moves the wiper blade. In the alternative, the mounting head is fixed for translation to a carriage, wherein the carriage can be translated alternately in a one linear direction and in another counter linear direction carrying the mounting head into translation. The present invention can therefore be used for circular or linear movement of the mounting head.

In a preferred embodiment of a windscreen wiper device in accordance with the present invention the electrically conductive coating is provided on an elongated lower wiping part of the wiper blade including a wiping lip thereof and facing away from an upper holding part of the wiper blade holding the longitudinal strip. Thus, the wiper blade consists of an elongated upper holding part and an elongated lower wiping part, wherein the upper holding part holds the longitudinal strip and wherein the wiping part comprises the wiping lip, and wherein the upper holding part and the lower wiping part are interconnected by means of a tilting web acting as an intermediate part subjected to a force in accordance with the wiping direction. Particularly, the tilting web is strip-shaped, whereas the wiping lip is triangular in shape. Instead of or in addition to applying the electrically conductive coating onto the triangular-shaped wiping lip the electrically conductive coating is provided on the elongated upper holding part of the wiper blade holding the longitudinal strip and facing away from the lower wiping part of the wiper blade comprising the wiping lip thereof. In the latter case the electrically conductive coating is particularly provided on a spoiler provided on the upper holding part. the elongated upper holding part and the elongated lower wiping part are preferably made in one piece through extrusion. In another preferred embodiment the elongated upper holding part and the elongated lower wiping part are separate parts connected together.

In another preferred embodiment of a windscreen wiper device according to the present invention the upper holding part comprises at least one channel extending along at least a portion of the length of the wiper blade, wherein an electrically conductive wire is disposed inside the channel for applying a voltage to the electrically conductive coating, and wherein the electrically conductive wire is in electrical contact with the electrically conductive coating. Preferably, the channel is located inside the upper holding part at a side thereof opposite to an air deflecting front side thereof and at a side of the groove facing away from a windscreen to be wiped. In another preferred embodiment there are two of these channels located on opposite lateral sides of the groove, the channel preferably extends along the entire length of the wiper blade.

In another preferred embodiment of a windscreen wiper device in accordance with the present invention at least two electrically conductive wires are provided on the upper holding part of the wiper blade on opposite sides thereof for applying a voltage to the electrically conductive coating, wherein the electrically conductive wires are in electrical contact with the electrically conductive coating. Particularly, the electrically conductive wires are located at opposite lateral sides of the groove. More in particular, the electrically conductive wires are inkjet on the flexible material of the wiper blade. In another preferred embodiment the electrically conductive wires are deposited with another method, such as serigraphy or paint rolling.

In another preferred embodiment of a windscreen wiper device according to the present invention the electrically conductive coating is an ink or paint containing Cu, Al or Ag. or any combination thereof. In an alternative also other very conductive materials may be used.

In the embodiments having (a) wire(s) the connecting device is preferably equipped with an electrical connection element to connect the wire(s) to a voltage generator.

As the earlier, the carrier element consists of one longitudinal strip disposed in a central longitudinal groove of the wiper blade. In the alternative, the carrier element consists of two longitudinal strips disposed in opposing longitudinal grooves of the wiper blade.

The present invention also relates to a process for manufacturing a windscreen wiper device comprising an elastic, elongated carrier element, as well as an elongated wiper blade of a flexible material, which can be placed in abutment with a windscreen to be wiped, which wiper blade includes at least one longitudinal groove, in which groove at least one longitudinal strip of the carrier element is disposed, which windscreen wiper device comprises a connecting device for an oscillating arm, wherein the oscillating arm is pivotally connected to the connecting device about a pivot axis near one end thereof, with the special feature that an electrically conductive coating is applied on at least a part of the flexible material of the wiper blade along at least a portion of its length in order to transfer electrically generated heat to the wiper blade upon applying a voltage to the electrically conductive coating.

### THE DRAWINGS

The invention will now be explained more in detail with reference to figures illustrated in a drawing, wherein

FIG. 1 is a perspective, schematic view of a preferred embodiment of a windscreen wiper device according to the invention; and

FIGS. 2 through 5 are a side and a perspective view of a wiper blade of the windscreen wiper device of FIG. 1 explaining the working principle, according to four embodiments, respectively, as to how to heat a electrically conductive coating applied on a spoiler of the wiper blade; and

FIG. 6 is a side view of a wiper blade of the windscreen wiper blade referring to a fifth embodiment.

### DETAILED DESCRIPTION

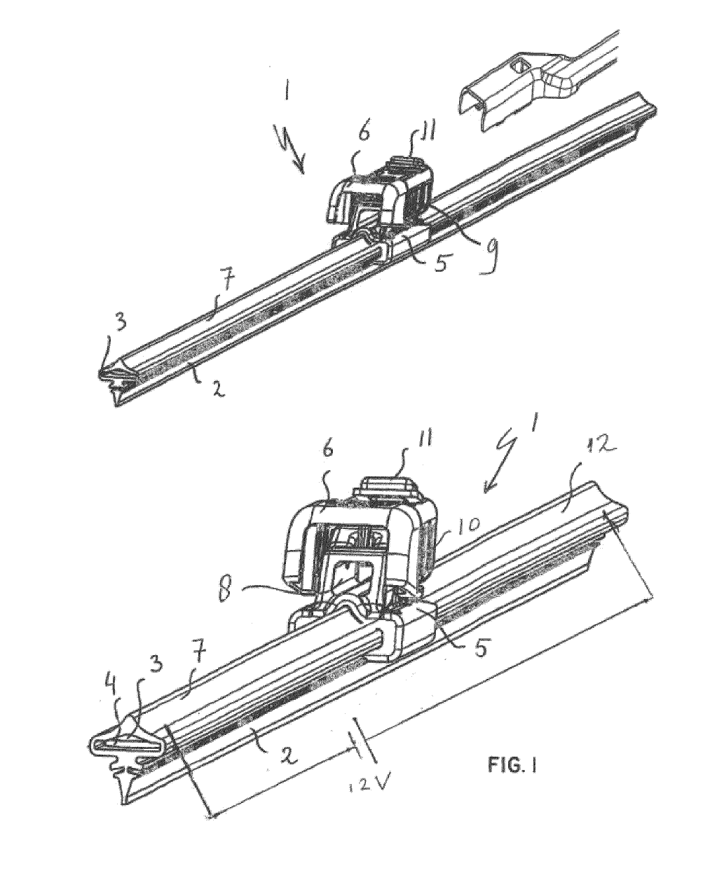

FIG. 1 shows a preferred variant of a windscreen wiper device 1 according to the invention. the windscreen wiper device 1 is built up of an elastomeric wiper blade 2 comprising a central longitudinal groove 3, wherein a longitudinal strip 4 made of spring band steel is fitted in the longitudinal groove 3, the strip 4 forms a flexible carrier element for the rubber wiper blade 2, as it were, which is thus biased in a curved position (the curvature in operative position being that of a windscreen to be wiped). The windscreen wiper device 1 is furthermore built up of a connecting device 5 of metal or plastic for connecting an oscillating wiper arm thereto, with the interposition of a joint part 6. The oscillating wiper arm is pivotally connected to the connecting device 5 about a pivot axis near one end. The preferred embodiment of FIG. 1 according to the invention comprises a spoiler or “air deflector” 7 which is made in one piece with the rubber wiper blade 2 and which extends along the entire length thereof. No end caps are used, but free ends of the wiper blade 2 are cut at an oblique angle. In the alternative end caps may be used.

Although not shown in FIG. 1, but fully understood by a skilled person, the oscillating arm is connected to a mounting head fixed for rotation to a shaft driven by a small motor.

In use, the shaft rotates alternately in a clockwise and in a counter-clockwise sense carrying the mounting head into rotation also, which in turn draws the oscillating arm into rotation and by means of the connecting device 5 moves the wiper blade 2.

the connecting device 5 further comprises an interior space 8 functioning as a water channel extending in longitudinal direction of the connecting device 5. During use the water channel 8 transports rain water therethrough. In other words, in use rain water is carried away from a first side of the connecting device 5 facing away from the free end of the oscillating arm to a second side of the connecting device 5 facing towards the free end of the oscillating arm. As a result of the oscillatory movement of the oscillating arm, in practice an over pressure relative to the environment exists at the location of the first side of the connecting device 5, while an under pressure relative to the environment is present at the location of the second side of the connecting device 5. Due to the over pressure and the under pressure rain water is “automatically” pressed through the water channel.

The joint part 6 is detachably connected to the connecting device 5 by engaging protrusions 9 of the connecting device 5, at the location of the pivot axis, in co-axial recesses 10 provided in the joint part 6. As shown, the protrusions 8 extend outwards on either side of the connecting device 5. The joint part 6 comprises a resilient tongue 11 extending outwardly, while the oscillating arm has a U-shaped cross-section at the location of its connection to the joint part 6, so that the tongue 11 engages in an identically shaped hole provided in a base of the U-shaped cross-section. The connecting device 5 with the wiper blade 2 is mounted onto the oscillating arm as follows. The joint part 6 being already clipped onto the connecting device 5 is pivoted relative to the connecting device 5, so that the joint part 6 can be easily slided on a free end of the oscillating arm. During this sliding movement the resilient tongue 11 is initially pushed in against a spring force and then allowed to spring back into the hole in the oscillating arm, thus snapping, that is clipping the resilient tongue 11 into the hole of the oscillating arm. This is a so-called bayonet-connection. The oscillating arm together with the joint part 6 may then be pivoted back in a position parallel to the wiper blade 2 in order to be ready for use. By subsequently pushing in again the resilient tongue 11 against the spring force (as if it were a push button), the connecting device 5 and the joint part 6 together with the wiper blade 2 may be released from the oscillating arm. Dismounting the connecting device 5 with the wiper blade 2 from the oscillating arm is thus realized by sliding the connecting device 5 and the joint part 6 together with the wiper blade 2 in a direction away from the oscillating arm.

According to the invention an electrically conductive coating 12 is disposed onto the spoiler 7 over the entire length of the wiper blade 2. In use a voltage of 12V or 24 V is applied across the electrically conductive coating 12 at both ends of the wiper blade 2, as shown.

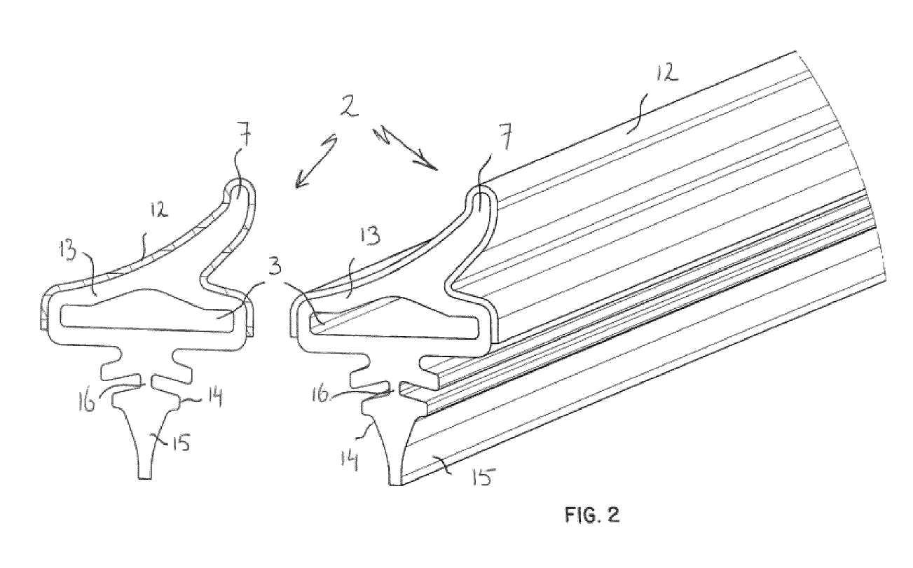

FIGS. 2 through 5 show a side and a perspective view of the wiper blade 2 of the windscreen wiper device of FIG. 1 according to four embodiments, respectively, explaining the working principle as to how to heat the electrically conductive coating 12 applied on the spoiler 7 of the wiper blade 2. As shown, the wiper blade 2 consists of an elongated upper holding part 13 and an elongated lower wiping part 14, wherein the upper holding part 13 holds the longitudinal strip 4 and wherein the lower wiping part comprises a wiping lip 15. the upper holding part 13 and the lower wiping part 14 are interconnected by means of a tilting web 16 acting as an intermediate part subjected to a force in accordance with the wiping direction.

In the first embodiment of FIGS. 1 and 2 a voltage is applied across the coating 12 along the entire length of the wiper blade.

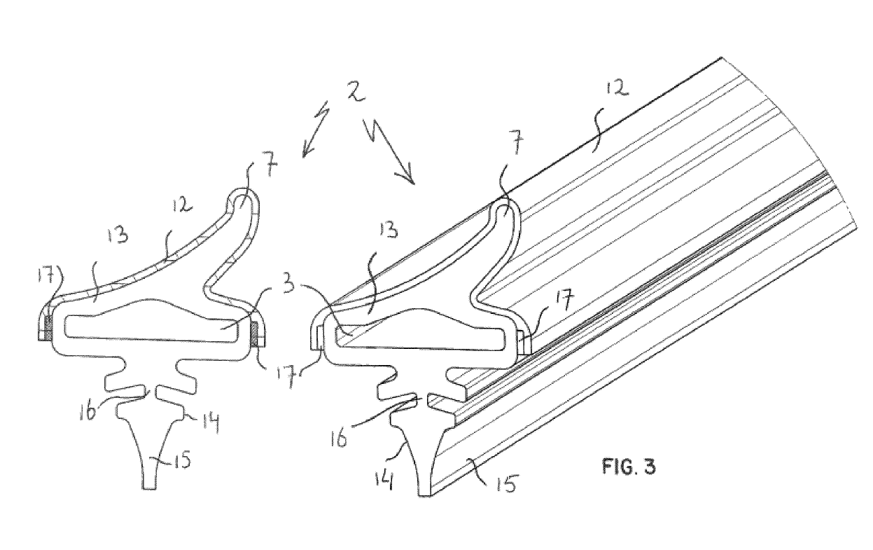

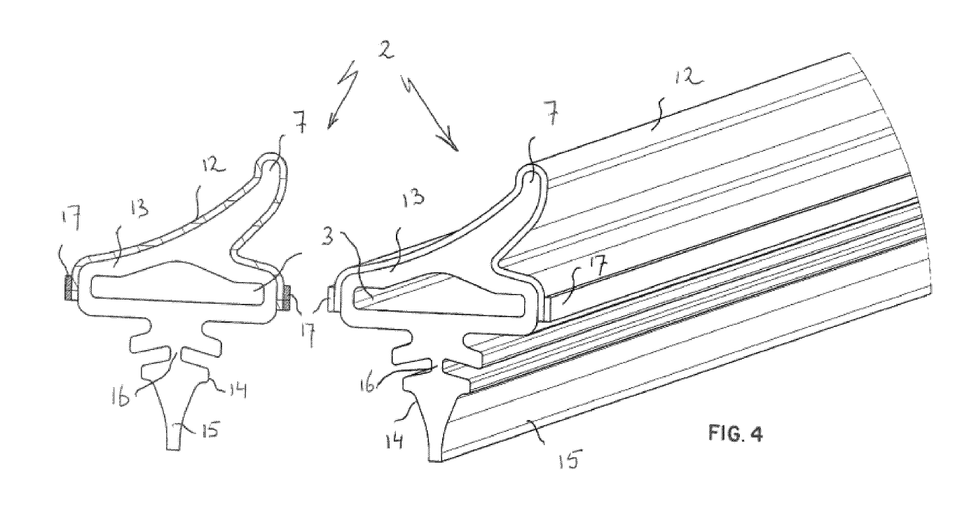

In the second alternative embodiment of FIG. 3 two electrically conductive wires or electrodes 17 are provided on the upper holding part 13 of the wiper blade 2 on opposite sides thereof and at opposite lateral sides of the groove 3. These wires 17 make contact with the electrically conductive coating 12 and serve to apply a voltage of 12 V, for example, to the electrically conductive coating 12. FIG. 4 shows a similar arrangement referring to a third embodiment, wherein the electrically conductive coating 12 is interposed between the wires 17 and the opposite lateral sides of the groove 3.

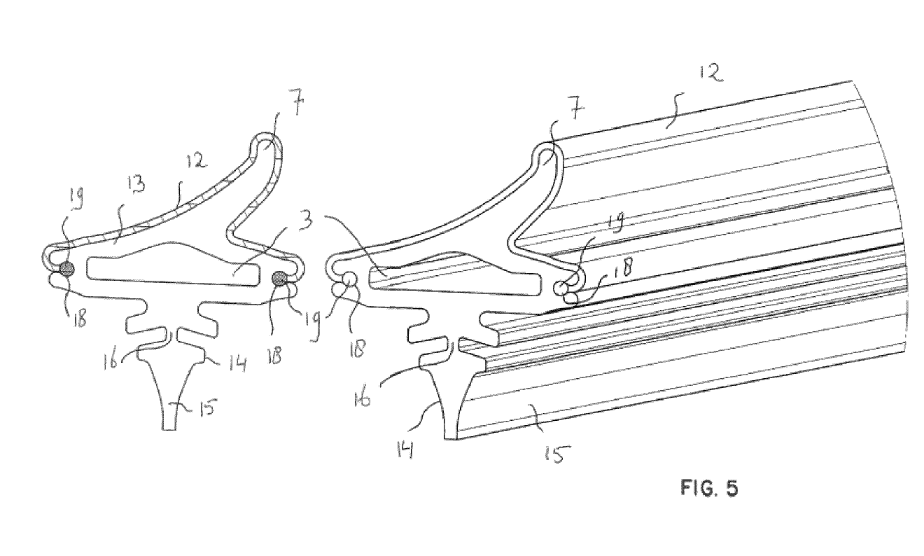

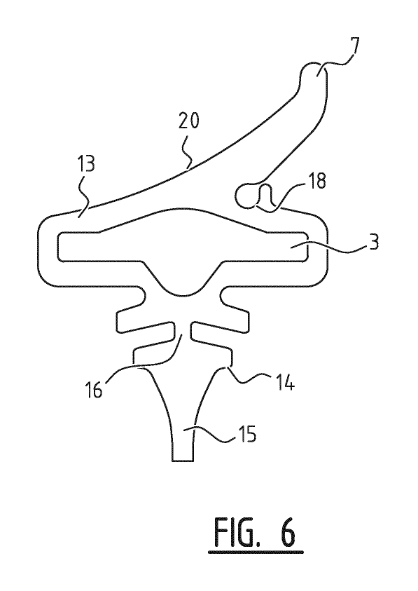

In the fifth alternative embodiment of FIG. 5 the upper holding part 13 comprises channels 18 extending along the entire length of the wiper blade 2. Inside the channels 18 electrically conductive wires or electrodes 19 being in electrical contact with the electrically conductive coating 12 are mounted for applying a voltage of 12 V, for example, to the electrically conductive coating 12. As depicted, the channels 18 are located at opposite lateral sides of the groove 3. FIG. 6 shows an arrangement according to a six embodiment, wherein the channel 18 is located inside the upper holding part 13 at a side thereof opposite to an air deflecting front side 20 thereof and at a side of the groove 3 facing away from a windscreen to be wiped. In FIG. 6 the coating 12 and the wire/electrode 19 are not visible.

In the embodiments of FIGS. 3 through 6 the connecting device 5 comprises an electrical connection element to connect the electrically conductive wires 17, 19 to a voltage generator.

1. A windscreen wiper device of the flat blade type, comprising an elastic, elongated carrier element, as well as an elongated wiper blade of a flexible material, which can be placed in abutment with a windscreen to be wiped, which wiper blade includes at least one longitudinal groove, in which groove at least one longitudinal strip of the carrier element is disposed, which windscreen wiper device comprises a connecting device for an oscillating arm and including an electrically conductive coating provided on at least a part of the flexible material of the wiper blade along at least a portion of its length in order to transfer electrically generated heat to the wiper blade upon applying a voltage to the electrically conductive coating.

2. A windscreen wiper device according to claim 1, wherein said electrically conductive coating is provided on an elongated lower wiping part of said wiper blade including a wiping lip thereof and facing away from an upper holding part of said wiper blade holding said longitudinal strip.

3. A windscreen wiper device according to claim 1, wherein said electrically conductive coating is provided on an elongated upper holding part of said wiper blade holding said longitudinal strip and facing away from a lower wiping part of said wiper blade including a wiping lip thereof.

4. A windscreen wiper device according to claim 3, wherein said electrically conductive coating is provided on a spoiler provided on said upper holding part.

5. A windscreen wiper device according to claim 3, wherein said upper holding part comprises at least one channel extending along at least a portion of the length of the wiper blade, wherein an electrically conductive wire is disposed inside said channel for applying a voltage to the electrically conductive coating, and wherein said electrically conductive wire is in electrical contact with said electrically conductive coating.

6. A windscreen wiper device according to claim 5, wherein said channel is located inside said upper holding part at a side thereof opposite to an air deflecting front side thereof and at a side of said groove facing away from a windscreen to be wiped.

7. A windscreen wiper device according to claim 5, wherein two channels are provided located at opposite lateral sides of said groove.

8. A windscreen wiper device according to claim 1, wherein at least two electrically conductive wires are provided on said upper holding part of said wiper blade on opposite sides thereof for applying a voltage to the electrically conductive coating, and wherein said electrically conductive wires are in electrical contact with said electrically conductive coating.

9. A windscreen wiper device according to claim 8, wherein said electrically conductive wires are located at opposite lateral sides of said groove.

10. A windscreen wiper device according to claim 8, wherein said electrically conductive wires are disposed on the flexible material of said wiper blade.

11. A windscreen wiper device according to claim 1, wherein said electrically conductive coating is an ink or paint.

12. A windscreen wiper device according to claim 11, wherein said ink or paint contains Cu, Al or Ag, or any combination thereof.

13. A windscreen wiper device according to claim 1, wherein said carrier element consists of one longitudinal strip disposed in a central longitudinal groove of said wiper blade.

14. A windscreen wiper device according to claim 1, wherein said carrier element consists of two longitudinal strips disposed in opposing longitudinal grooves of said wiper blade.

15. A method of making a windscreen wiper device of the flat blade type comprising preparing an elastic, elongated carrier element, as well as an elongated wiper blade of a flexible material, which can be placed in abutment with a windscreen to be wiped, and to include at least one longitudinal groove, in which groove at least one longitudinal strip of the carrier element is disposed, preparing a connecting device for an oscillating arm; and providing an electrically conductive coating on at least a part of the flexible material of the wiper blade along at least a portion of its length in order to transfer electrically generated heat to the wiper blade upon applying a voltage to the electrically conductive coating.

16. The method of claim 15, wherein the coating is applied by ink jet.

17. The method of claim 15, wherein the coating is selected from electrically conductive ink or print.

18. The method of claim 17 wherein the ink or paint is selected to contain one or more in combination of Cu, Al and Ag.
